(19) United States
(12) Patent Application Publication
(10) Pub. No.: US 2008/0231597 A1
(43) Pub. Date: Sep. 25, 2008

(54) Wireless mouse receiver with camera

(76) Inventor: Ho-Lung Lu, Panchiao (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/723,988

(22) Filed: Mar. 23, 2007

(51) Int. Cl. G09G 5/08

(52) U.S. Cl. 345/163

(57) ABSTRACT

A wireless mouse receiver with a camera includes a receiver body, a rotary connection piece, and a signal-receiving unit. The receiver body has a fixed piece and a movable piece. The fixed piece is provided with a connection port for being electrically connected with a computer. The movable piece is provided with a camera unit. The rotary connection piece is connected between the fixed piece and the movable piece. Rotating the rotary connection piece causes the movable piece to rotate. The camera unit on the movable piece can perform the camera function at different angles. The signal-receiving unit is provided in the receiver body. With the above arrangement, a user only needs to use one connection port of the computer to simultaneously operate a wireless mouse and the camera unit, thereby utilizing the connection ports of the computer more efficiently.

### BACKGROUND OF THE INVENTION

1. Field of the Invention

The present invention relates to a wireless mouse receiver with a camera, and in particular to an expansion and improvement of the functions of a wireless mouse receiver.

2. Description of Prior Art

A mouse is a necessary basic device for a computer. Since peripheral products tend to be wireless, wireless mice have become more and more popular. However, when a wireless mouse is used, a connection port of the computer will be occupied for electrically connecting with the wireless mouse receiver.

With the rapid progress of Microsoft Messenger software and other similar video technologies, web cameras have become a necessary peripheral device for computers. The current web camera is electrically connected with the computer via a transmission line. When the user uses a wireless mouse and a web camera, at least two connection ports of the computer will be occupied. Since the computer and the peripheral products tend to be miniaturized and wireless, it is inevitable that many novel peripheral products will be continuously developed. Therefore, if each peripheral product needs a transmission line and occupies a connection port of the computer, the connection ports of the computer will become insufficient. Furthermore, such a method of connection wastes the hardware resources of a computer and is inefficient. Moreover, the entanglement of many transmission lines is not aesthetically pleasing. Also, dust accumulates easily around all of these areas.

There are two ways to increase the number of connection ports of a computer. One is to expand the area of the motherboard of the computer. This solution increases production costs and departs from the tendency of computer technology towards miniaturization, thus lacking competitiveness in the future. The second method is not to change the area of the motherboard of the computer, but to develop a new specifications for the computer for receiving more connection ports therein. However, such a solution still increases production costs. After all, it is unwise to change the specifications of the computer just for one peripheral product, which does not confirm to the proportional principle in the industry.

Alternatively, in line with the progression of electronic miniaturization techniques, many electronic products have multiple functions. However, conventional wireless mice still have only one function. Therefore, owing to the rapid evolution of modern technology, such a single-function wireless mouse will soon become less and less competitive. Furthermore, when a video function is needed, it is inportable a wireless mouse, a wireless mouse receiver and a web camera.

Therefore, in view of the above drawbacks, the inventor proposes the present invention to efficiently overcome the drawbacks of prior art based on his deliberate researches and expert experiences.

### SUMMARY OF THE INVENTION

In view of the above problems, the object of the present invention is to provide a wireless mouse receiver with a camera, which efficiently utilizes the hardware resources of the computer, has a pleasant appearance and reduced cost, increases industrial competitiveness and is portable.

In order to achieve the above objects, the present invention provides a wireless mouse receiver with a camera, which comprises: a receiver body having a fixed piece and a movable piece. The fixed piece is provided with a connection port and the movable piece is provided with a camera unit. A rotary connection piece is connected between the fixed piece and the movable piece, and a signal receiving unit is provided in the receiver body.

The present invention produces the following advantages. The camera unit is provided in the movable piece of the receiver body so that the user can use only one connection port of the computer to simultaneously operate the wireless mouse and the camera unit, thereby efficiently utilizing the resources of the computer. It is unnecessary to spend money and time to change the specifications of the computer. Furthermore, one connection port can be left for other peripheral devices, thereby allowing the functions of the computer to be performed more efficiently. Alternatively, the camera unit can communicate with the computer without any transmission lines, thereby omitting the transmission line and producing a pleasant appearance. The receiver body and the camera unit are integrally formed together, so that the wireless mouse can act as a multiple-function electronic device and be more competitive. Furthermore, the receiver body is very portable, so the user only needs to carry the receiver body and the wireless mouse.

### BRIEF DESCRIPTION OF THE DRAWINGS

FIG. 1 is a perspective view of the first embodiment of the present invention;

FIG. 2 is a schematic view (I) showing the rotation of the rotary connection piece of the present invention;

FIG. 3 is a schematic view (II) showing the rotation of the rotary connection piece of the present invention;

FIG. 4 is a perspective view of the second embodiment of the present invention;

FIG. 5 is a perspective view (I) of the third embodiment of the present invention;

FIG. 6 is a perspective view (II) of the third embodiment of the present invention;

FIG. 7 is a perspective view of the fourth embodiment of the present invention;

FIG. 8 is a perspective view of the fifth embodiment of the present invention;

FIG. 9 is a perspective view of the sixth embodiment of the present invention;

FIG. 10 is a perspective view of the seventh embodiment of the present invention;

FIG. 11 is a perspective view of the eighth embodiment of the present invention; and

FIG. 12 is a perspective view of the ninth embodiment of the present invention.

### DETAILED DESCRIPTION OF THE INVENTION

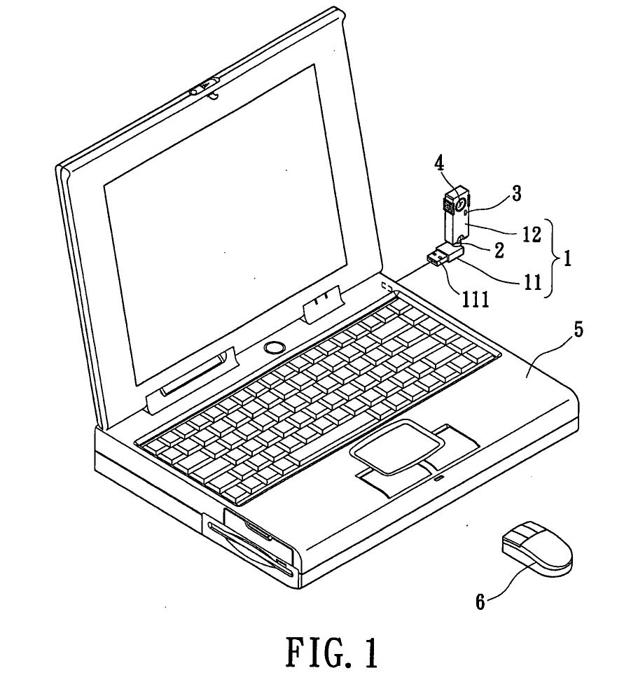

The first embodiment of the present invention is shown in FIG. 1. The present invention is directed to a wireless mouse receiver with a camera, which comprises a receiver body 1, a rotary connection piece 2, and a signal-receiving unit 3. The receiver body 1 comprises a fixed piece 11 and a movable piece 12. The fixed piece 11 is provided with a connection port 111. The connection port 111 is a USB or an IEEE1394. The movable piece 12 is provided with a camera unit 4. The camera unit 4 is built in the movable piece 12. The connection port 111 can be electrically connected with a computer 5.

The rotary connection piece 2 is a universal joint and connected between the fixed piece 11 and the movable piece 12.

The signal-receiving unit 3 is a bluetooth wireless communication-receiving module for receiving electronic signals sent from the wireless mouse 6. The signal-receiving unit 3 can be a GSM wireless communication-receiving module. The signal-receiving unit 3 is provided in the movable piece 12 or onto the fixed piece 11 of the receiver body 1 (not shown).

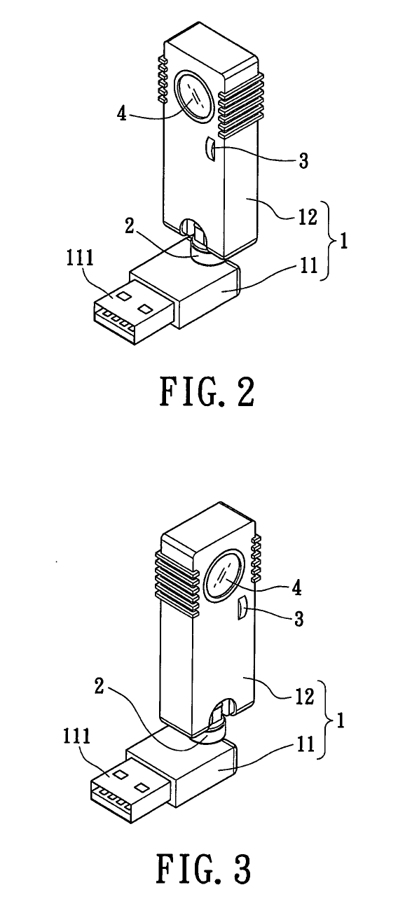

As shown in FIGS. 2 and 3, the rotation of the rotary connection piece 2 causes the rotation of the movable piece 12, this allows the camera unit 4 located on the movable piece 12 to perform the camera functions at different angles.

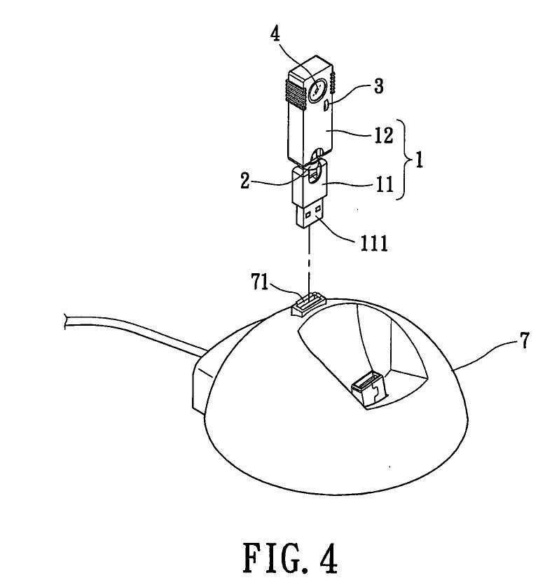

The second embodiment of the present invention is shown in FIG. 4. The connection port 111 can be inserted into a base 7. The base 7 can be a charging base and is provided with a connection port 71. The connection port 111 of the fixed piece 11 is electrically connected with the connection port 71 of the base 7. The transmission line of the base 7 is electrically connected with the computer 5 (not shown).

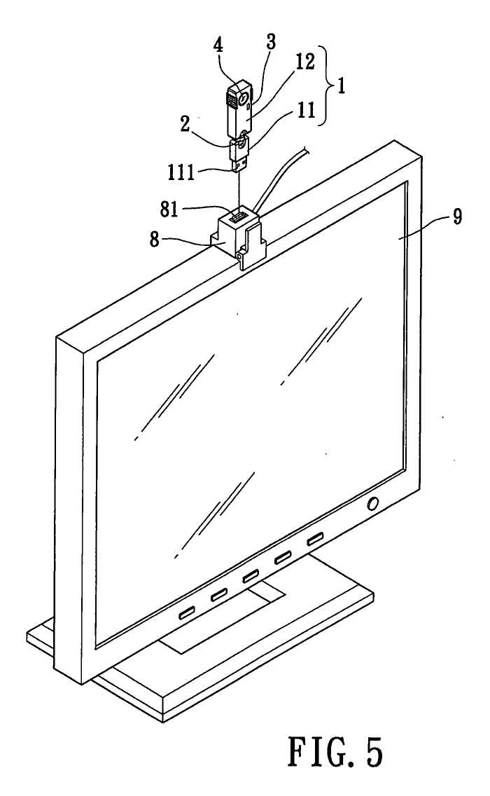

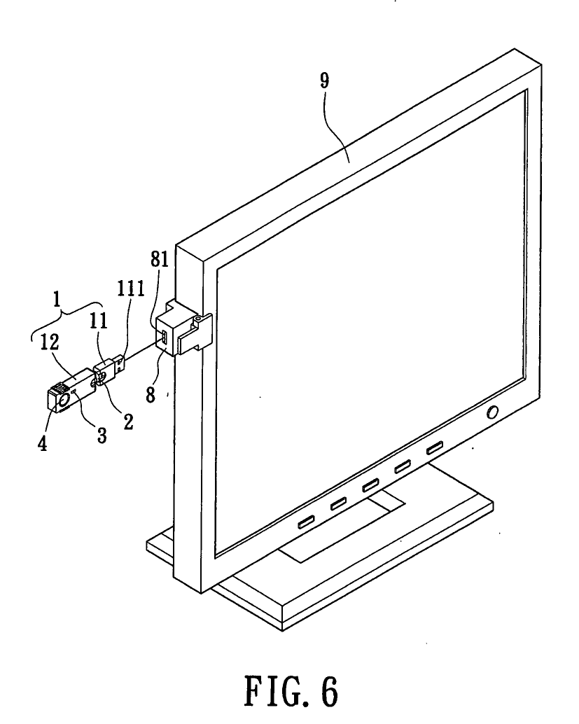

The third embodiment of the present invention is shown in FIGS. 5 and 6. The connection port 111 can be inserted into and electrically connected with a fixing clamp 8. The fixing clamp 8 is provided with a connection port 81. The connection port 111 of the fixing piece 11 is electrically connected with the connection port 81 of the base 8. The transmission line of the fixing clamp 8 is electrically connected with the computer 5 (not shown). Due to the fixing clamp 8, the present invention can be easily clamped at any position of a computer screen 9.

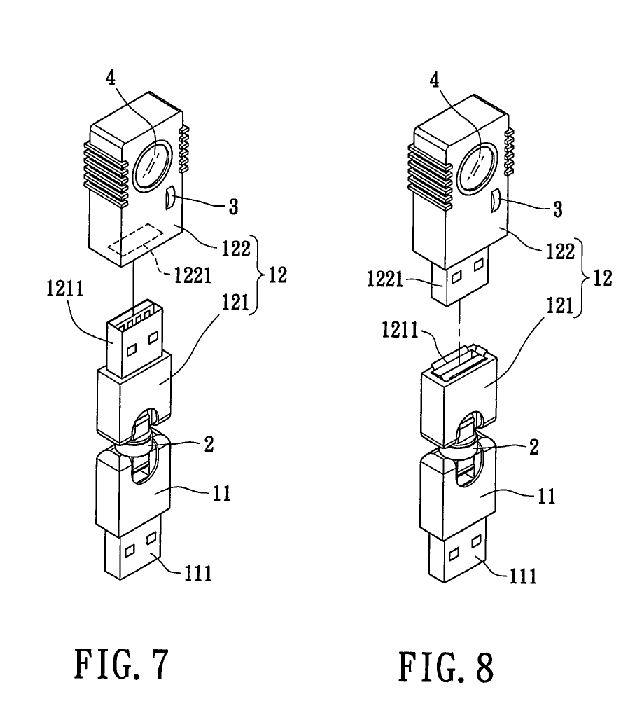

A fourth embodiment of the present invention is shown in FIG. 7. The movable piece 12 comprises a connecting portion 121 and a camera portion 122. The connecting portion 121 is connected with the rotary connection piece 2. The camera unit 4 is provided in the camera portion 122. The connecting portion 121 is provided with a first connector 1211, and the camera portion 122 is provided with a second connector 1221. The first connector 1211 and the second connector 1221 are a male USB and a female USB, respectively. The first connector 1211 is electrically connected with the second connector 1221. The first connector 1211 and the second connector 1221 may be an IEEE1394.

A fifth embodiment of the present invention is shown in FIGS. 8 and 7. The first connector 1211 and the second connector 1221 are a female USB and a male USB, respectively. The first connector 1211 and the second connector 1221 may be IEEE1394s.

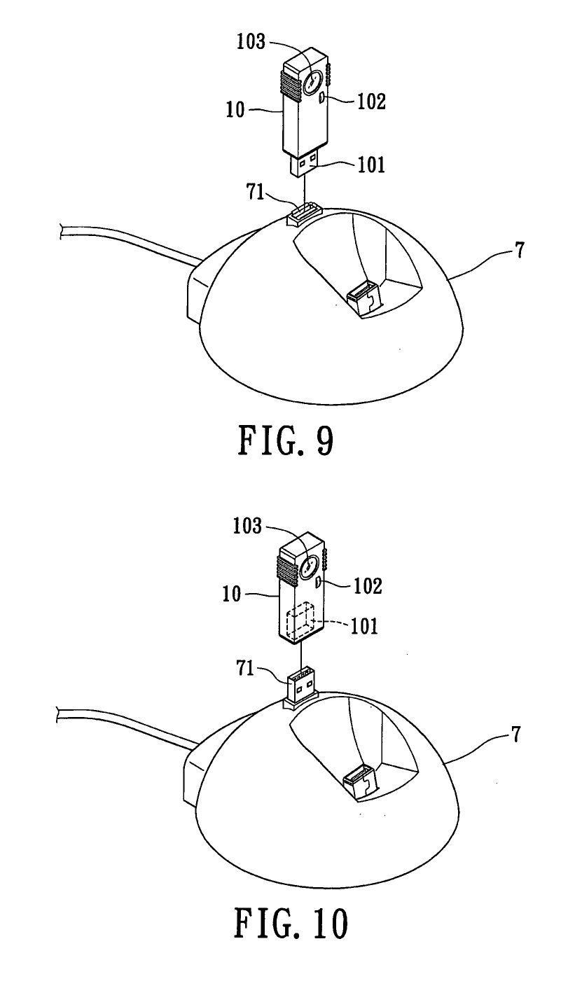

FIG. 9 and FIG. 10 show the sixth and seventh embodiments of the present invention, respectively. A receiver body 10 is provided with a connection port 101, a signal receiving unit 102, and a camera unit 103. The connection port 101 can be a USB or an IEEE1394. The signal-receiving unit 102 is a bluetooth wireless communication-receiving module or a GSM wireless communication-receiving module. The connection port 101 can be electrically connected with the connection port 71 of the base 7. The transmission line of the base 7 is electrically connected with the computer 5 (not shown).

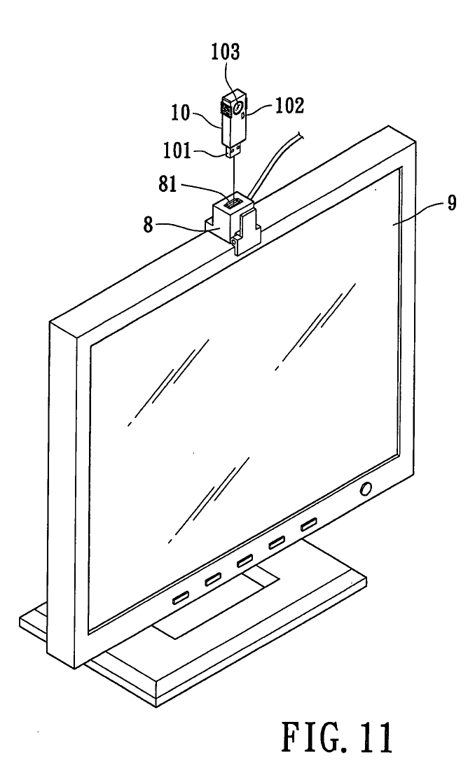

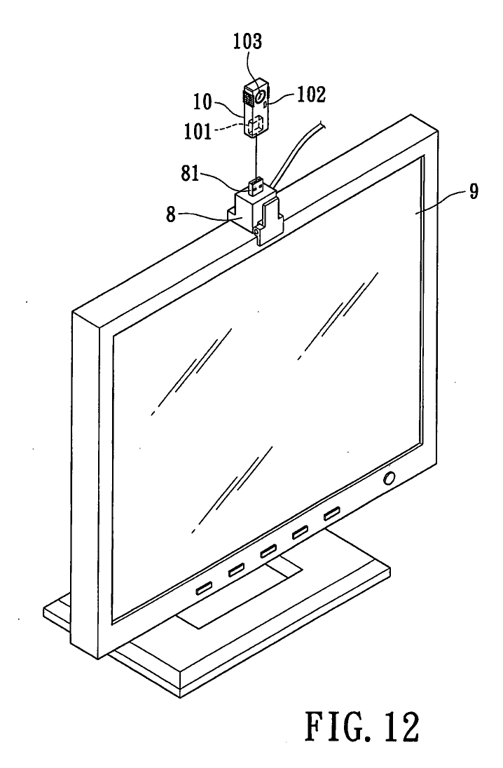

FIG. 11 and FIG. 12 show the eighth and ninth embodiments of the present invention, respectively. The connection port 101 of the receiver body 10 can be electrically connected with the connection port 81 of the fixing clamp 8. The transmission line of the fixing clamp 8 is electrically connected with the computer 5 (not shown). Due to the fixing clamp 8, the present invention can be easily clamped to the computer screen 9.

The wireless mouse receiver with a camera in accordance with the present invention has the following advantages.

(1) The camera unit 4 is provided in the movable piece 12 of the receiver body 1, so that the user can use only one connection port of the computer 5 to simultaneously operate the wireless mouse 6 and the camera unit 5, thereby efficiently utilizing the hardware resources of the computer 5. It is not necessary to spend a lot of time and money to change the specifications of the computer 5. Furthermore, one connection port of the computer 5 can be left for other peripheral devices, thereby performing the functions of the computer 5 more efficiently.

(2) The camera unit 4 can be in communication with the computer 5 without any transmission line, thereby omitting the transmission line and producing a pleasant appearance.

(3) The connection port 111 of the fixing portion 11 can be inserted into and electrically connected with a fixing clamp 8. Due to the fixing clamp 8, the present invention can be easily clamped at any position of the computer screen 9.

(4) The camera unit 4 and the receiver body 1 are integrally formed together, so that the wireless mouse 6 can act as a multiple-function electronic device and have greater industrial competitiveness. Furthermore, the receiver body 1 is very portable, so the user can perform a video function by only carrying the receiver body 1 and the wireless mouse 6.

Although the present invention has been described with reference to the foregoing preferred embodiments, it will be understood that the invention is not limited to the details thereof Various equivalent variations and modifications may still occur to those skilled in this art in view of the teachings of the present invention. Thus, all such variations and equivalent modifications are to be embraced within the scope of the invention as defined in the appended claims.

What is claimed is:

1. A wireless mouse receiver with a camera, comprising:
a receiver body having a fixed piece and a movable piece, the fixed piece has a connection port and the movable piece has a camera unit;
a rotary connection piece connected between the fixed piece and the movable piece; and
a signal-receiving unit provided in the receiver body

2. The wireless mouse receiver with a camera according to claim 1, wherein the rotary connection piece is a universal joint.

3. The wireless mouse receiver with a camera according to claim 1, wherein the movable piece comprises a connecting portion and a camera portion, the connecting portion is connected with the rotary connection piece, the camera portion is provided in the camera portion, the connecting portion is provided with a first connector, the camera portion is provided with a second connector, and the first connector is electrically connected with the second connector.

4. The wireless mouse receiver with a camera according to claim 3, wherein the first connector and the second connector are USBs or IEEE 1394s.

5. The wireless mouse receiver with a camera according to claim 1, wherein the connection port is a USB or an IEEE1394.

6. The wireless mouse receiver with a camera according to claim 1, wherein the connection port is inserted into and electrically connected to a base.

7. The wireless mouse receiver with a camera according to claim 6, wherein the base is a charging base.

8. The wireless mouse receiver with a camera according to claim 1, wherein the connection port is inserted into and electrically connected to a fixing clamp.

9. The wireless mouse receiver with a camera according to claim 1, wherein the camera unit is built in the movable piece.

10. The wireless mouse receiver with a camera according to claim 1, wherein the signal-receiving unit is a bluetooth wireless communication-receiving module or a GSM wireless communication-receiving module.

11. A wireless mouse receiver with a camera, comprising:
a receiver body provided with a connection port and a signal-receiving unit; and
a camera unit provided in the receiver body.

12. The wireless mouse receiver with a camera according to claim 11, wherein the connection port is a USB or an IEEE1394.

13. The wireless mouse receiver with a camera according to claim 11, wherein the connection port is inserted into and electrically connected to a base.

14. The wireless mouse receiver with a camera according to claim 13, wherein the base is a charging base.

15. The wireless mouse receiver with a camera according to claim 11, wherein the connection port is inserted into and electrically connected to a fixing clamp.

16. The wireless mouse receiver with a camera according to claim 11, wherein the camera unit is built in the movable piece.

17. The wireless mouse receiver with a camera according to claim 11, wherein the signal-receiving unit is a bluetooth wireless communication-receiving module or a GSM wireless communication-receiving module.
